(19) United States
(12) Patent Application Publication
(10) Pub. No.: US 2023/0035237 A1
(43) Pub. Date: Feb. 2, 2023

(54) METHOD FOR OCT WELD SEAM MONITORING AND ALSO ASSOCIATED LASER PROCESSING MACHINE AND COMPUTER PROGRAM PRODUCT

(71) Applicant: TRUMPF Laser GmbH, Schramberg (DE)

(72) Inventors: Martin Stambke, Dunningen (DE); Jan-Patrick Hermani, Markgroeningen (DE); Christian Flaig, Schramberg (DE); Dagmar Abendschein, Schramberg - Sulgen (DE)

(21) Appl. No.: 17/951,118

(22) Filed: Sep. 23, 2022

Related U.S. Application Data
(63) Continuation of application No. PCT/EP2021/058000, filed on Mar. 26, 2021.

(30) Foreign Application Priority Data
Mar. 27, 2020 (DE) 10 2020 203 983.6

(51) Int. Cl. B23K 26/03; B23K 26/044; B23K 26/082; B23K 26/24

(52) U.S. Cl. CPC B23K 26/032; B23K 26/044; B23K 26/082; B23K 26/24

(57) ABSTRACT

A method for monitoring a curved solidified weld seam during the welding of a workpiece includes carrying out distance measurements using a measurement beam of an optical coherence tomograph both at one or more pre-measurement points situated upstream of a present welding position, and at one or more post-measurement points situated downstream of the present welding position, and monitoring the curved, solidified weld seam on the basis of the distance measurements. In the case of a plurality of post-measurement points, a post-measurement line is formed from the plurality of post-measurement points and positioned to be offset relative to a pre-measurement line in the direction of the pre-measurement line toward the curved, solidified weld seam and/or is rotated relative to the pre-measurement line. In the case of a single post-measurement point, spacing the single post-measurement point from a line passing through the present welding position in the welding direction.

### CROSS REFERENCE TO RELATED APPLICATIONS

This application is a continuation of International Application No. PCT/EP2021/058000 (WO 2021/191440 A1), filed on Mar. 26, 2021, and claims benefit to German Patent Application No. DE 10 2020 203 983.6, filed on Mar. 27, 2020. The aforementioned applications are hereby incorporated by reference herein.

### FIELD

The present invention relates to a method for monitoring a curved weld seam by means of a measurement beam of an optical coherence tomograph (optical coherence tomography, OCT) during the welding of a workpiece by means of a processing laser beam, comprising the following method steps:
during the welding, carrying out distance measurements by means of the measurement beam both at at least one pre-measurement point situated upstream of a present welding position, as viewed in the welding direction, and at at least one post-measurement point situated downstream of the present welding position, as viewed in the welding direction, in each case by deflecting the measurement beam on the workpiece, and
monitoring the curved weld seam on the basis of the post-distance measurements.

### BACKGROUND

Such a method for OCT weld seam monitoring has been disclosed by DE 10 2016 014 564 A1.

During laser beam welding, the exact positioning of the laser beam relative to the workpieces is accorded particular importance. On account of the limited accuracy of positioning systems and the customary component tolerances, systems which detect the position of the workpieces and control the position of the laser beam accordingly are indispensable. Typically, for this purpose, the position of a geometric feature is detected in advance of the laser beam. After the further processing of said feature, the position of the laser beam is controlled relative thereto. During the laser beam welding of fillet weld seams at the lap joint, the edge of the upper metal sheet is usually used as a geometric feature for the positioning of the laser beam. The geometry of the solidified weld seam can be measured subsequently to the process. The geometric variables thus obtained are used for the exterior appraisal of the weld seam and provide information about the quality of the welded connection.

Commercially customary seam tracking control systems are based on imaging light section or reflected light methods. OCT (optical coherence tomography)-based methods have also been used relatively recently. OCT-based systems employ an OCT (small field) scanner that moves the OCT measurement beam rapidly over the component. An OCT distance measurement image is then calculated from the individual measurement points, the measured OCT distance being plotted along the measurement points in said image. By comparison with the widely used light section method, OCT-based systems afford the advantage that the scanning figure of the OCT (small field) scanner can be altered during processing.

A major role during seam position control is accorded to the image processing algorithms that determine the position of geometric features or geometric measurement variables. In the case of a lap joint of two metal sheets, the position of the upper metal sheet edge is determined in advance of the laser beam (so-called pre-measurement), and seam features for the evaluation of the solidified seam are determined subsequently (so-called post-measurement). The reliability of the algorithms essentially depends on the position of the region of interest (pre-region: upper metal sheet edge, post-region: solidified weld seam) in the OCT distance measurement image. In the image generated by means of OCT, it is necessary to determine the surfaces of the metal sheets by means of image processing algorithms. One important step here is the interpolation of lines of the metal sheet surfaces from the available image data. If the interpolation length alongside the geometric features is too short, the interpolation becomes uncertain. If the regions available for the interpolation in the OCT distance measurement image are too small, for example, the result becomes inaccurate or cannot be determined. If the trajectory of the laser beam describes a curved path, incorrect positioning of the post-measurement line occurs. Displacement of the seam geometry in a direction away from the curved weld seam occurs in the OCT distance measurement image. As a result, not enough information to be able to calculate the geometric seam features is available to the image processing algorithm.

### SUMMARY

In an embodiment, the present disclosure provides a method for monitoring a curved solidified weld seam during the welding of a workpiece using a processing laser beam moving in a welding direction. The method includes carrying out distance measurements during the welding using a measurement beam of an optical coherence tomograph both at one or more pre-measurement points situated upstream of a present welding position relative to the welding direction, and at one or more post-measurement point situated downstream of the present welding position relative to the welding direction, the distance measurements being carried out by deflecting the measurement beam on the workpiece. The method also includes monitoring the curved, solidified weld seam on the basis of the distance measurements. If the distance measurements are carried out at a plurality of post-measurement points, a post-measurement line is formed from the plurality of post-measurement points and positioned to be offset relative to a pre-measurement line formed from a plurality of pre-measurement points in the direction of the pre-measurement line toward the curved, solidified weld seam and/or rotated relative to the pre-measurement line in the direction toward the normal to the curved, solidified weld seam. If the distance measurements are carried out at a single post-measurement point, the single post-measurement point is positioned be spaced apart from a line passing through the present welding position in the welding direction further in the direction toward the curved, solidified weld seam than each pre-measurement point.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a laser processing machine for carrying out the method according to the invention;

FIGS. 2A and 2B show a method for monitoring a straight weld seam (FIG. 2A) and a curved weld seam (FIG. 2B) by means of an OCT measurement beam according to the prior art, in each case with associated OCT distance measurement images; and

FIGS. 3A, 3B, and 3C show a method according to the invention for monitoring a curved weld seam by means of an OCT measurement beam, in each case with associated OCT distance measurement images.

### DETAILED DESCRIPTION

Against this background, the invention is based on the object of developing a method of the type mentioned in the introduction to the effect that the curved weld seam can be detected as optimally as possible in the OCT distance measurement image.

This object is achieved according to the invention by virtue of the fact that for the case of a post-measurement line formed from a plurality of post-measurement points, the post-measurement line is positioned in such a way that the post-measurement line is offset relative to a pre-measurement line, formed from a plurality of pre-measurement points, in the direction of the pre-measurement line toward the curved, solidified weld seam and/or is rotated relative to the pre-measurement line in the direction toward the normal to the curved, solidified weld seam, and that for the case of a single post-measurement point, the single post-measurement point is positioned in such a way that it is spaced apart from a line, passing through the present welding position in the welding direction, further in the direction toward the curved, solidified weld seam than each pre-measurement point.

The dynamic positioning of the post-measurement line, and of the single post-measurement point, respectively, according to the invention enables a considerably stabler and more exact evaluation of the post-measurement data. On the basis of the post-distance measurements, the solidified weld seam can subsequently be geometrically measured and monitored. A significantly stabler and more accurate measurement of geometric seam features thus becomes possible.

Particularly preferably, the post-measurement line is positioned in such a way that the line center point of the post-measurement line lies on the curved, solidified weld seam. In this case, the OCT distance measurement image can be optimally evaluated.

The post- and pre-measurement lines can be for example a straight measurement line or a curved, self-contained or open measurement line. Particularly advantageously, the post-measurement line intersects the curved, solidified weld seam at an angle of 90°±10°, in particular 90°. In these cases, the OCT distance measurement image can be optimally evaluated. In one preferred embodiment, the pre- and post-measurement lines are identical, i.e. are of equal length in the case of straight measurement lines.

In one particularly advantageous variant, the post-measurement line is moved into its measurement position from an initial location, unrotated relative to the pre-measurement line and spaced apart equidistantly from the line, by displacing the post-measurement line by an offset and/or by rotating the post-measurement line by a rotation angle. The offset and/or rotation angle of the post-measurement line required for this purpose can be determined on the basis of a position of the curved, solidified weld seam calculated e.g. from the trajectory of the processing laser beam.

For the case of a single post-measurement point, the measurement position of the single post-measurement point is preferably chosen in such a way that it lies on the curved, solidified weld seam.

The invention also relates to a laser processing machine comprising a laser beam generator for generating a processing laser beam, comprising a laser scanner for two-dimensionally deflecting the processing laser beam on a workpiece, comprising an optical coherence tomograph for generating an OCT measurement beam that is directed onto the workpiece by the laser scanner, comprising an OCT scanner arranged between coherence tomograph and laser scanner and serving for two-dimensionally deflecting the OCT measurement beam on the workpiece, and comprising a machine controller for controlling the laser scanner and the OCT scanner, wherein according to the invention the machine controller is programmed to position the post-measurement line or the single post-measurement point in accordance with the method according to the invention.

Finally, the invention also relates to a computer program product comprising code means adapted for carrying out all of the steps of the method according to the invention when the program runs on a machine controller of a laser processing machine

Further advantages and advantageous configurations of the subject matter of the invention can be gathered from the description, the drawings and the claims. Likewise, the features mentioned above and those that will be explained further can be used in each case by themselves or as a plurality in any desired combinations. The embodiments shown and described should not be understood as an exhaustive enumeration, but rather are of illustrative character for outlining the invention.

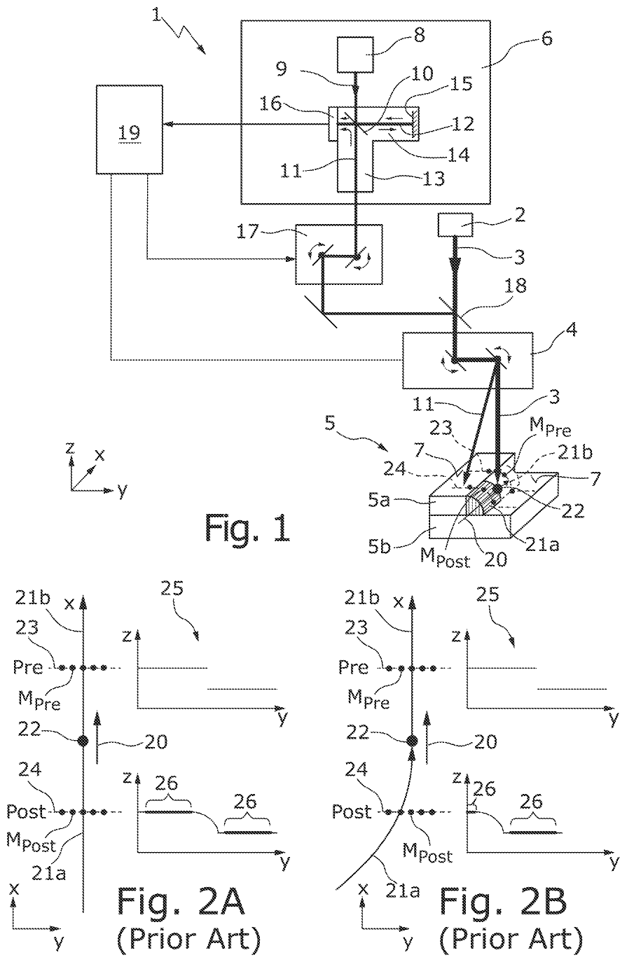

The laser processing machine 1 shown schematically in FIG. 1 comprises a laser beam generator 2 for generating a processing laser beam 3, a laser scanner 4 for two-dimensionally deflecting the processing laser beam 3 in x-, y-directions on a workpiece 5, and also an optical coherence tomograph (OCT) 6 for optically scanning a region of the surface 7 of the workpiece 5. The laser scanner 4 can have for example one scanner mirror deflectable about two axes, or two scanner mirrors each deflectable about one axis.

The OCT 6 has in a known manner an OCT light source (e.g. superluminescence diode) 8 for generating a light beam 9, a beam splitter 10 for splitting the light beam 9 into an OCT measurement beam 11 and a reference beam 12. The OCT measurement beam 11 is forwarded to a measuring arm 13 and impinges on the workpiece surface 7, at which the OCT measurement beam 11 is at least partly reflected and guided back to the beam splitter 10, which is nontransmissive or partly transmissive in this direction. The reference beam 12 is forwarded to a reference arm 14 and reflected by a mirror 15 at the end of the reference arm 14. The reflected reference beam is likewise guided back to the beam splitter 10. The superimposition of the two reflected beams is finally detected by a detector (OCT sensor) 16 in order, taking account of the length of the reference arm 14, to ascertain height information about the workpiece surface 7 and/or the current penetration depth of the processing laser beam 3 into the workpiece 5. This method is based on the fundamental principle of the interference of light waves and makes it possible to detect height differences along the measurement beam axis in the micrometers range.

Adjacent to the measuring arm 13 there follows an OCT (small field) scanner 17 in order to deflect the OCT measurement beam 11 two-dimensionally, i.e. in x-, y-directions, on the workpiece surface 7 and thus to scan a region of the workpiece surface 7 with line scans, for example. The OCT scanner 17 can have for example one scanner mirror deflectable about two axes, or two scanner mirrors each deflectable about one axis. Via a mirror 18 that is arranged obliquely in the beam path of the processing laser beam 3 and is transmissive for the processing laser beam 3 and reflective for the OCT measurement beam 11, the OCT measurement beam 11 is coupled into the laser scanner 4 in order to direct the OCT measurement beam 11 onto the workpiece 5. The sensor data of the OCT sensor 16 are passed to a machine controller 19, which also controls the movement of the scanners 4, 17.

FIG. 1 shows the welding of two workpiece parts 5a, 5b lying one on top of the other with a lap joint by means of the processing laser beam 3, which is guided along the abutting edge of the two workpiece parts 5a, 5b (welding direction 20) in order to weld the two workpiece parts 5a, 5b to one another by means of a weld seam 21a, 21b running along the abutting edge. The solidified weld seam is designated by 21a and the weld seam that is still to be produced is designated by 21b. The present welding position, i.e. the point of impingement of the processing laser beam 3 on the workpiece 5, is designated by 22.

During the welding, by means of the OCT measurement beam 11, distance measurements are carried out both at a plurality of pre-measurement points M_{Pre} of the workpiece surface 7 that are situated upstream of the present welding position 22, as viewed in the welding direction 20, and at a plurality of post-measurement points M_{Post} of the workpiece surface 7 that are situated downstream of the present welding position 22, as viewed in the welding direction 20. For this purpose, the OCT measurement beam 11 is correspondingly deflected on the workpiece surface 7 by means of the OCT scanner 17. As shown in FIG. 1, the plurality of pre-measurement points M_{Pre} are arranged along a pre-measurement line 23 running transversely over the weld seam 21b to be produced, and the plurality of post-measurement points M_{Post} are arranged along a post-measurement line 24 running transversely over the solidified weld seam 21a. On the basis of the post-distance measurements, the solidified weld seam 21a can subsequently be geometrically measured and monitored.

In known methods for monitoring a straight, solidified weld seam 21a (FIG. 2A) and a curved, solidified weld seam 21a (FIG. 2B) by means of an OCT measurement beam 11, the same scanning figure is used for the pre- and post-measurement lines 23, 24, namely for example pre- and post-measurement lines 23, 24 of equal length which run parallel and without an offset with respect to one another in the y-direction and are oriented at right angles and centrally with respect to the welding direction 20 running in the x-direction at the present welding position 22. To put it more precisely, firstly the pre-measurement line 23 is defined and then this scanning figure is also adopted for the post-measurement line 24.

As shown in FIG. 2A, in the case of a straight weld seam 21a, 21b, the pre- and post-measurement lines 23, 24 are positioned with their line center points in each case on the weld seam 21a, 21b. As a result, the respective regions of interest of the workpiece surface 7, i.e. firstly the step of the lap joint in the pre-region and secondly the solidified weld seam 21a in the post-region, are optimally detected in the OCT distance measurement images 25, in which the measured distance (height in the z-direction) is plotted along the measurement lines 23, 24. By contrast, if the solidified weld seam 21a is curved, as shown in FIG. 2B, the curvature results in incorrect positioning of the post-measurement line 24 and thus in displacement of the region of interest (solidified weld seam 21a) in the OCT distance measurement image 25 in a direction away from the curved weld seam 21a. Less image information is thus available, which results in an inadequate interpolation length 26, for example.

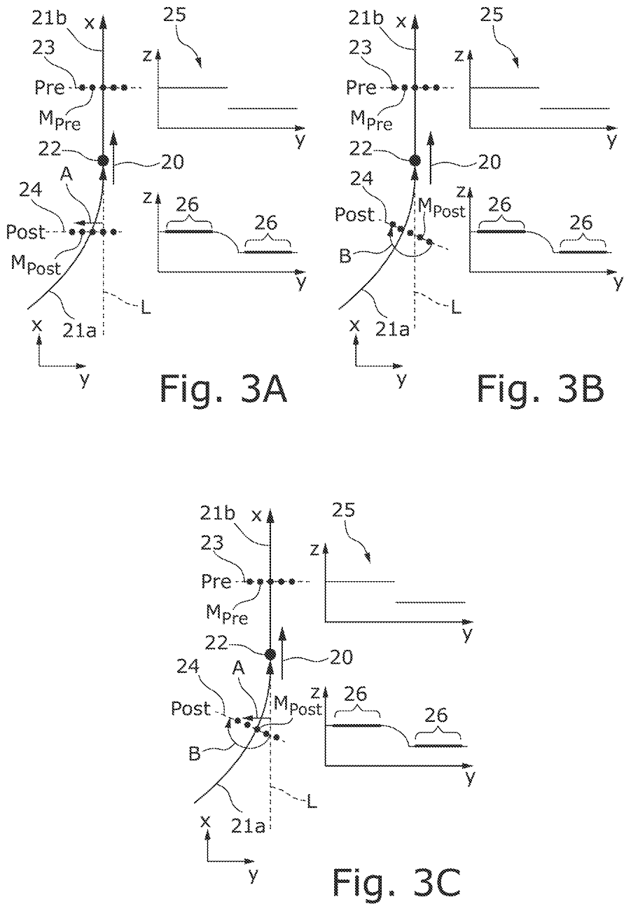

FIGS. 3A-3C show three variants of the method according to the invention for monitoring the curved, solidified weld seam 21a by means of the OCT measurement beam 21 in each case with associated OCT distance measurement diagrams 25, specifically on the basis of the example of straight pre- and post-measurement lines 23, 24 of equal length. Alternatively, the pre- and post-measurement lines 23, 24 can also be curved, self-contained or open measurement lines.

In FIG. 3A, the post-measurement line 24 is offset by an offset A relative to the pre-measurement line 23 in the direction of the pre-measurement line 23 toward the curved, solidified weld seam 21a. For this purpose, the post-measurement line 24 can be displaced for example relative to the initial location, non-offset and parallel to the pre-measurement line 23 and shown in FIGS. 2A, 2B, toward the curved, solidified weld seam 21a into its measurement position shown in FIG. 3A, specifically preferably until the line center point of the post-measurement line 24 lies on the curved, solidified weld seam 21a. As a result, the solidified weld seam 21a is optimally detected in the OCT distance measurement image 25. The offset A required for this purpose can be determined for example on the basis of a position of the curved, solidified weld seam 21a calculated e.g. from the trajectory of the processing laser beam 3.

In FIG. 3B, the post-measurement line 24 is rotated relative to the pre-measurement line 23 by an angle B in the direction toward the normal to the curved, solidified weld seam 21a. For this purpose, the post-measurement line 24 can be rotated relative to the initial location, non-offset and parallel to the pre-measurement line 23 and shown in FIGS. 2A, 2B, about an arbitrary point, in particular about a line point (such as e.g. the line center point) of the non-offset post-measurement line 24, into its measurement position shown in FIG. 3B, specifically preferably until the post-measurement line 24 intersects the curved, solidified weld seam 21a at an angle of 90°. As a result, the solidified weld seam 21a is optimally detected in the OCT distance measurement image 25. The rotation angle B required for this purpose can be determined for example on the basis of a position of the curved, solidified weld seam 21a calculated e.g. from the trajectory of the processing laser beam 3.

In FIG. 3C, the post-measurement line 24 is both offset by the offset A and rotated by the rotation angle B relative to the pre-measurement line 23. Preferably, the line center point of the post-measurement line 24 lies on the curved, solidified weld seam 21a and the post-measurement line 24 intersects the curved, solidified weld seam 21a at an angle of 90°.

According to the invention, therefore, the position of the post-measurement line 24 is adapted translationally (FIG. 3A), rotationally (FIG. 3B) or translationally and rotationally (FIG. 3C) such that the region of interest is positioned optimally in the image portion. As a result, the determination of the geometric seam features becomes significantly more reliable and more exact. The offset A and the rotation angle B of the post-measurement line 24 are calculated on the basis of input variables which either are communicated by some other part of the system or controller (motion vector) or come from the system itself. Examples of system measurement values are the lateral setting angle measured in advance, the length of the metal sheets in the pre-image and also the position of the upper metal sheet edge. A closed-loop control algorithm uses the measured or estimated position (post-measurement value) of the solidified weld seam 21a as an input variable.

Instead of a plurality of post-measurement points M_{Post} forming a post-measurement line 24, just a single post-measurement point M_{Post} can also be used, which is then positioned in such a way that it is spaced apart from a line L (FIGS. 3A-3C), passing through the present welding position 22 in the welding direction 20, further in the direction toward the curved, solidified weld seam 21a than each pre-measurement point M_{Pre}. Preferably, the measurement position of the single post-measurement point M_{Post} is chosen in such a way that it lies on the curved, solidified weld seam 21a.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for monitoring a curved solidified weld seam during the welding of a workpiece using a processing laser beam moving in a welding direction, the method comprising:
during the welding, carrying out distance measurements using a measurement beam of an optical coherence tomograph both at at least one pre-measurement point situated upstream of a present welding position relative to the welding direction, and at at least one post-measurement point situated downstream of the present welding position relative to the welding direction, the distance measurements being carried out by deflecting the measurement beam on the workpiece, and
monitoring the curved, solidified weld seam on the basis of the distance measurements,
wherein if the distance measurements are carried out at a plurality of post-measurement points, forming a post-measurement line from the plurality of post-measurement points and positioning the post-measurement line so as to be offset relative to a pre-measurement line formed from a plurality of pre-measurement points, wherein the offset is in the direction of the pre-measurement line toward the curved, solidified weld seam and/or is rotated relative to the pre-measurement line in the direction toward the normal to the curved, solidified weld seam, and
if the distance measurements are carried out at a single post-measurement point, positioning the single post-measurement point so as to be spaced apart from a line passing through the present welding position in the welding direction further in the direction toward the curved, solidified weld seam than each pre-measurement point.

2. The method according to claim 1, wherein the post-measurement line is positioned in such a way that the line center point of the post-measurement line lies on the curved, solidified weld seam.

3. The method according to claim 1, wherein the post-measurement line and the pre-measurement line run straight or the post-measurement line and the pre-measurement line run in a curved fashion.

4. The method according to claim 1, wherein the post-measurement line is positioned in such a way that the post-measurement line intersects the curved, solidified weld seam at an angle of 90°±10°.

5. The method according to claim 1, wherein the pre- and post-measurement lines are identical.

6. The method according to claim 5, wherein the post-measurement line is moved into its measurement position from an initial location, unrotated relative to the pre-measurement line and spaced apart equidistantly from the line, by displacing the post-measurement line by an offset and/or by rotating the post-measurement line by a rotation angle.

7. The method according to claim 6, wherein the offset and/or the rotation angle are/is determined on the basis of a calculated position of the curved, solidified weld seam.

8. The method according to claim 6, wherein the post-measurement line is rotated relative to the initial location, non-offset and parallel to the pre-measurement line, about an arbitrary point into its measurement position.

9. The method according to claim 1, wherein the measurement position of the single post-measurement point is chosen so as to lie on the curved, solidified weld seam.

10. A laser processing machine comprising:
a laser beam generator for generating a processing laser beam,
a laser scanner for two-dimensionally deflecting the processing laser beam on a workpiece,
an optical coherence tomograph for generating an OCT measurement beam that is directed onto the workpiece by the laser scanner,
an OCT scanner disposed between the coherence tomograph and the laser scanner and configured to two-dimensionally deflect the OCT measurement beam on the workpiece, and
a machine controller configured to control the laser scanner and the OCT scanner,
wherein the machine controller is programmed to position the post-measurement line or the single post-measurement point(M_{Post}) in accordance with the method according to claim 1.

11. A computer program product comprising code running on a machine controller of a laser processing machine and adapted for carrying out all of the steps of the method according to claim 1.
